(19) United States
(12) Patent Application Publication
(10) Pub. No.: US 2002/0189593 A1
(43) Pub. Date: Dec. 19, 2002

(54) Injector driving control apparatus

(76) Inventors: Makoto Yamakado, Tsuchiura (JP); Noriyuki Maekawa, Chiyoda (JP); Kiyotaka Ogura, Hitachinaka (JP); Kazutaka Hino, Hitachinaka (JP); Tohru Ishikawa, Kitaibaraki (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/173,413

(22) Filed: Jun. 18, 2002

(30) Foreign Application Priority Data
Jun. 18, 2001 (JP) 2001-182710

(51) Int. Cl. H01H 9/00; F02M 51/00

(52) U.S. Cl. 123/490; 361/154

(57) ABSTRACT

Providing an injector driving control apparatus that operates with minimum power consumption while ensuring linearity (proportionality between the current supply duration and fuel injection volume of the injector) in a wide fuel pressure range. Providing a coil current feedback circuit and controlling the current feedback duration according to fuel pressure after applying the current at a boost voltage. The present invention enables optimal control of the injector and hence, the improvement of its fuel injection volume characteristics (linearity) and the reduction of the heat generated in the injector driving control circuits.

### BACKGROUND OF THE INVENTION

1. Field of the Invention

The present invention relates to an injector driving control apparatus intended for supplying a fuel to an internal combustion engine; more particularly to the technology for achieving a wide dynamic fuel pressure range by controlling a fuel injection volume according to the waveform of the current generated, instead of changing in a wide range the supply fuel pressure to the injector mentioned above.

2. Prior Art

Under such prior art as set forth in Japanese Application Patent Laid-Open Publication No. Hei 06-241137, two target current levels for the initial phase of magnetic attraction, namely, a high current target value and a low current target value are determined by the excitation current control corresponding to changes in fuel supply pressure, and thus the durability, reliability, and efficiency of fuel injection solenoid valves are improved.

The injector controls the injection volume according to the time for which the current is to be supplied. Such operation that ensures linearity (proportionality between the current supply duration and fuel injection volume of the injector) in a wide fuel pressure range causes the following events:

The time from the start of supply of the current to the opening of the valve, that is, a delay in the opening timing of the valve differs between a low fuel pressure status and a high fuel pressure status.

After valve opening, the time from the end of supply of the current to the closing of the valve has a relationship with the coil current value obtained during the end of supply of the current, and as the coil current value at this time increases, the time to the closing of the valve (namely, a delay in the closing timing of the valve) becomes longer and the amount of fuel injected during this time increases.

These events, in turn, create the following problems:

If the current value is set for a low fuel pressure, increases in the fuel pressure will prevent the valve from opening, or even if the valve opens, there will be a great delay in the opening of the valve. Therefore, since the application of a voltage higher than the battery voltage will have been completed by the time the valve opens, it will not be possible for the open status of the valve to be maintained. This problem relates to the duration of the current waveform.

Conversely, if the current value is set for a high fuel pressure, decreases in the fuel pressure will cause the valve to close too early. If the current supply duration is reduced to inject a smaller amount of fuel, supply of the current will be terminated when the current value is high, in spite of the fact that the application of a voltage higher than the battery voltage will not yet have been completed. Under such a situation, compared with the situation that the current supply duration increases and supply of the current is terminated with a low current value, the valve closing delay time increases and this, in turn, increases the injection volume and deteriorates linearity in a small injection volume region. This problem relates to the current value of the current waveform.

Also, the coil of the injector needs to have a low resistance and a low inductance to improve the valve opening/closing response of the injector.

Even if the application of the art disclosed in FIG. 4 of Japanese Application Patent Laid-Open Publication No. Hei 06-241137 is to be attempted for the above problems, since the corresponding art uses a coil low in inductance, unless the high target current value is changed significantly, it will not be possible to clear the above-described problem relating to the duration of the current waveform. Therefore, in view of the scale of circuit elements and the heat therefrom, the application of the above art is not realistic. Also, even if the application of the art disclosed in FIG. 9 of Japanese Application Patent Laid-Open Publication No. Hei 06-241137 is to be attempted, the corresponding art cannot be adopted since increases in the application duration of a voltage higher than the battery voltage will reduce the boost voltage and generate a great amount of heat.

### SUMMARY OF THE INVENTION

To solve the problems described above, it is necessary to adjust either the current value of the coil when a boost voltage is not applied thereto, or the duration of a large current value. More specifically, the coil current is to be increased to great enough a value by applying a boost voltage to open the valve, and immediately after the valve has opened, a closed circuit is to be formed by using the coil of the injector and a current feedback diode. After this, the magnetic energy stored within the coil is to be utilized to maintain its energized status without a voltage being applied, and this feedback duration of the current is to be adjusted according to the fuel pressure obtained.

For this reason, the injector driving control apparatus according to the present invention comprises an injector for supplying a fuel to an internal combustion engine, a switching means for energizing the coil of said injector from a battery, a control circuit for said switching means, a means for detecting the current flowing through the coil of the injector, a current feedback diode for feeding back the coil current of the injector, and a means for reducing abruptly the coil current of the injector, designed so that a voltage is supplied to the coil of said injector from the start of energization to the attainment of a first target current value, then control is provided so as to stop the application of the voltage temporarily on the attainment of said first target current value and so as to supply the appropriate current by forming a closed circuit composed of the coil and said current feedback diode, and thereafter the said abrupt current feedback means is activated so as to ensure that the current value, when greater than a second current value smaller than said first current value, is reduced and then that the appropriate voltage is applied to obtain said second current value, and further constructed so that the operation timing of the abrupt current feedback means is determined by comparison between the coil current value that has been detected by said detection means, and the value that has been set, and said operation timing can also be changed according to the timing command signal sent from said control circuit. In addition, there is provided a means for detecting the pressure of the fuel supplied to the injector, and when the fuel pressure increases, the operation timing of the abrupt current feedback means will be changed for delayed operation.

Also, the coil current follow-up control section for obtaining each of said target current values is constructed so that the first stage of the control accomplishes energization by applying a boost voltage higher than the voltage of said battery and so that the second stage of the control accomplishes energization by applying the battery voltage.

### DESCRIPTION OF THE INVENTION

One embodiment of the injector driving control apparatus according to the present invention is described in detail below using drawings.

FIG. 1 is a block diagram for realizing the operation of the present invention.

Injector driving control apparatus 0 sends to a CPU 5 at least a reference position signal 3a, which indicates the piston position of an internal combustion engine that is detected by an internal combustion engine rotation detector 3, and an angle signal 3b, which indicates the rotational speed of the internal combustion engine. In CPU 5, a fuel pump 6 for supplying a fuel to the injector 8 is controlled by a fuel pump control signal 5a, and the pressure of the fuel to be supplied to injector 8 is detected by a fuel pressure sensor 9. The resulting signal is sent to CPU 5 as a fuel pressure signal 9a. Supply of power to injector driving control apparatus 0 is accomplished by supplying the voltage of a battery 1 as a battery power signal 1a, and after converting this signal into the optimal voltage level by use of a regulated voltage circuit 4, supplying the converted voltage to CPU 5 as a regulated voltage signal 4a. The voltage level of the battery 1 is converted into the optimal voltage level as the input of the CPU 5 by a voltage dividing circuit 2, and the optimal voltage is supplied to CPU 5 as a battery voltage dividing signal 2a. After receiving this signal, CPU 5 performs calculations to ensure the optimal timing of fuel injection into the internal combustion engine, and sends the results to an injector driving circuit 7 via an injection pulse signal 5b and a valve opening pulse signal 5c. These signals are then used by the injector driving circuit 7 to provide control using an injector driving signal 7a and an injector driving GND signal 7b.

This embodiment assumes a single-cylinder internal combustion engine, and the processes occurring until the optimal fuel injection according to the operational status of this internal combustion engine has been incorporated into injector 8 are described below.

In order to inject the optimal amount of fuel from the injector, CPU 5 sends an injection fuel pressure signal, an injection pulse signal, and an valve opening pulse signal to fuel pump 6 and injector driving circuit 7 via signal lines 5a, 5b, and 5c, respectively. The injection pulse signal 5b is obtained by converting into the valve opening duration of injector 8 the optimal volume of fuel injection that has been calculated from signals such as the reference position signal 3a and angle signal 3b (these are the output signals of internal combustion engine rotation detector 3), fuel pressure signal 9a, and battery voltage dividing signal 2a. The valve opening pulse signal 5c is obtained from CPU 5 after the sufficient time from the start of valve opening of injector 8 according to the particular level of the fuel pressure signal 9a, to the arrival of the valve at its opening position and the change to a valve-open hold status, has been calculated from signals such as fuel pressure signal 9a and battery voltage dividing signal 2a, by the CPU.

Injector driving circuit 7 uses injection pulse signal 5b and valve opening pulse signal 5c to control the valve of injector 8 via signal lines 7a and 7b.

A flowchart explaining the operation of the present invention is shown as FIG. 2.

In CPU 5, the optimal volume of fuel injection is calculated according to the particular operational status (rotational speed, load, etc.) of the internal combustion engine, then the results are converted into a fuel pressure, injection timing, and an injection duration, and injection pulse signal 5b is sent to injector driving circuit 7 (step S100 in the figure). At the same time, the sufficient time from the start of valve opening of the injector according to the detected fuel pressure, to the arrival of the valve at its opening position and the change to a valve-open hold status, is calculated by CPU 5 and valve opening pulse signal 5c is sent to injector driving circuit 7 (S100). After injector driving circuit 7 has received injection pulse signal 5b (S101), the first target current value 11 for activating the valve of the injector to start opening is set by injector driving circuit 7 (S102), and the injector is energized with a boost voltage greater than the battery voltage (S103). At this time, the magnitude of the current flowing through the injector is monitored (S104) and when the valve of the injector starts opening and arrives at the first target current value 11 (SlO5), the injector will be de-energized (S106). At the same time, clamping current value 12 smaller than the first target current value 11 is set (S106) to continue the opening motion of the valve until its open status has been maintained. This clamping current value becomes one of the two driving initiation conditions relating to the abrupt current feedback circuit composed of a Zener diode that is shown in the circuit composition of FIG. 3. Other condition is the turn-off timing of the valve opening pulse signal.

The value of the current flowing through the injector is monitored (S107) and when the monitored current value decreases below 12 (S108) or when the valve opening pulse signal turns off (S109), injector driving circuit 7 consumes the coil current by means of a Zener diode and abruptly reduce the current value. At the same time, a second target current value 13 smaller than clamping current value 12 is set to hold the open status of the valve (S110). At this time, the value of the current flowing through the injector is monitored (S111) and when the monitored current value decreases below 13 (S112), the injector current is controlled to the target current value 13 by means of the battery voltage (S113). After injection pulse signal 5b has turned off (S114), energization with the battery voltage is stopped (S115) and the valve of the injector is moved to the opening position of the valve (S115).

FIG. 3 is an internal circuit diagram of the injector driving circuit 7 shown in FIG. 2.

Signal line 7a, one of the two driving signal lines for injector 8, connects the source of an FET 37, which is provided to apply a boost voltage signal 10a created by a boosting circuit 10 (for example, a DC-DC converter), and the cathode of a diode 34. The anode of the diode 34 is connected to the source of an FET 33 provided to apply a battery voltage 1a to injector 8. Diode 34 prevents the signal lines of the battery voltage 1a and boost voltage 10a from being short-circuited via the parasitic diode of the FET 33 when FET 37 is on. Diode 38 holds the current of injector 8 in a free-wheel status when boost voltage 10a is cut off by FET 37.

Signal line 7b, the other driving signal line for injector 8, is connected to the drain of the FET 35 so as to establish the route for the flow of the current into injector 8 when injection pulse signal 5b is turned on. The source of the FET 35 is connected to the GND signal line 1b of the above-mentioned battery 1 via a resistor 36 to detect the current flowing through injector 8. The current flowing through injector 8 is converted into a voltage value by the resistor 36, from which the voltage value is then sent to the minus terminals of comparators 18 and 20 via a signal line 36a.

When the flow of the current into FET 35 is cut off, the coil current is consumed by a Zener diode 40 and changed into thermal energy to generate heat. The generation of heat becomes significant if the flow of a particularly strong current into FET 35 is cut off.

Numeral 42 denotes a single-shot pulse generator, which is needed to construct a pulse signal that determines the startup timing of the abrupt current reduction implemented by Zener diode 40.

The operation of circuits is described below using FIGS. 3 and 4.

The application of boost voltage 10a to injector 8 is described first. The plus terminal of the comparator 18 has a connected signal line 18a, which carries a signal that has been created by dividing the output voltage 4a of a regulated voltage circuit 4 by resistors 15 and 16. The voltage level of the signal line 18a is provided with a hysteresis by means of a resistor 17. Signal line 18a sets the voltage level having a correlation with respect to the voltage value 36a obtained by converting the current value of injector 8. That is to say, a voltage level equivalent to the first target current value 11 is set for signal line 18a. Comparator 18 compares voltage level 36a equivalent to the injector current value of the signal line connected to the minus terminal of the comparator, and the current value setting of the signal line connected to the plus terminal of the comparator, that is to say, a voltage level 18a equivalent to the first target current value 11. The current value obtained immediately after injection pulse signal 5b has been turned on is small since the current has just begun flowing into injector 8, and voltage value 36a equivalent to this current value is also small. In other words, since the minus terminal of comparator 18 is smaller than its plus terminal, the output 18b of comparator 18 takes a high level. When the current value of injector 8 progressively increases, voltage value 36a equivalent to this current value also increases and thus the voltage level at the minus terminal of comparator 18 increases above the voltage level detected at its plus terminal. At this time, the output 18b of comparator 18 takes a low level. When the output 18b of comparator 18 takes a high level, an AND gate 23 generates a high-level output signal, only while output of injection pulse signal 5b is maintained. The high-level signal from the AND gate turns on a transistor 29 via a base resistor 25. When transistor 29 is on, the voltage 37a obtained by dividing boost voltage 10a by resistors 27 and 28 is applied to the gate of the FET 37, with the result that FET 37 is turned on to apply boost voltage 10a to the other signal line, 7a, of injector 8. Similarly, when the output 18b of comparator 18 takes a low level, FET 37 is turned off to cut off the boost voltage 10a that has been applied to injector 8. In this way, the first target current value 11 to be applied to injector 8 is controlled.

Here, the values of resistors 15, 16, and 17 are set to the slice levels of 11 and 13.

Next, the operation of injector 8 in its current feedback mode is described. When FET 37 is turned off and the application of the boost voltage is terminated, FET 35 is on, provided that the injection command signal is at a high level. At this time, the coil of injector 8 forms a closed circuit with a terminal 7b, a detection resistor 36, FET 35, a free-wheel diode (current feedback diode) 38, and a terminal 7a. Consequently, the coil current that has been enhanced by the boost voltage flows into the closed circuit mentioned above and its energy is consumed by a coil resistor and a detection resistor 37. As described above, however, since the coil resistor is small-sized to satisfy response requirements, the attenuation of the current is sluggish. In this current feedback mode, therefore, it is possible to continue supplying a strong current to the coil without applying a voltage.

Next, operation in abrupt current feedback mode is described. During input of the valve opening pulse signal, voltage 18b whose signal level was low under the cutoff status of the boost voltage when the value of the current being fed back became equal to 12 is active (see FIG. 4). Hereby, single-shot pulse generator 42 generates a short pulse signal. Thus, an AND operation is performed between this reversal signal and injection command pulse input 5a, resulting in the driving signal of FET 35 being obtained. When FET 35 is turned off, the current that has been flowing into FET 35 is consumed by Zener diode 40, with the result that the current is abruptly reduced.

Next, the application of battery voltage 1a to injector 8 in order to make the current come up with the second target coil current 13 is described.

When input of valve opening pulse signal 5c is on, FET 12 is on and a voltage signal line 20a carrying a signal obtained by dividing the output voltage 4a of regulated voltage circuit 4 by parallel resistors 11 and 13 and a resistor 14, is connected to the plus terminal of comparator 20. The voltage level of the signal line 20a is provided with a hysteresis by means of a resistor 19. Comparator 20 compares voltage level 36a equivalent to the injector current value of the signal line connected to the minus terminal of the comparator, and the current value setting of the signal line connected to the plus terminal of the comparator, that is to say, a voltage level 20a equivalent to the second target current value 13. When the minus terminal is smaller than the plus terminal in terms of voltage, that is to say, when the current value of injector 8 is smaller than the second target current value 12, the output of comparator 20 takes a high level. Conversely, when the minus terminal is greater than the plus terminal in terms of voltage, that is to say, when the current value of injector 8 is greater than the second target current value 13, the output of comparator 20 takes a low level. When the output 20b of comparator 20 takes a high level, an AND gate 24 generates a high-level output signal, only while output of injection pulse signal 5b is maintained. The high-level signal from the AND gate turns on a transistor 32 via a base resistor 26. When transistor 32 is on, the voltage 33a obtained by dividing battery voltage 1a by resistors 30 and 31 is applied to the gate of the FET 33, with the result that FET 33 is turned on to apply battery voltage 1a to the other signal line, 7a, of injector 8. Similarly, when the output 20b of comparator 20 takes a low level, FET 33 is turned off to cut off the battery voltage 1a that has been applied to injector 8. In this way, the second target current value 12 to be applied to injector 8 is controlled.

The embodiment of the present invention using the control circuits of the above-described composition is described in further detail below. FIG. 5 shows an injection pulse, a valve opening pulse, a coil current, valve body driving force, the valve displacement in injector 8, and the injection volume with respect to the injection pulse width.

The example shown in FIG. 5 applies to the case in which the abrupt current reduction circuit is activated with a large opening valve pulse width, Tb, by arrival at previously set current value 12, not by the fall of the opening valve pulse. The figure also assumes a relatively low fuel pressure.

When the valve body driving force exceeds zero (T1), valve displacement occurs and fuel injection is started.

The valve body driving force is resultant force consisting of physical factors such as the magnetic attraction force excited by the coil, spring force for assigning the force which returns the valve body in the closing direction of the valve, and fuel pressure for pushing the valve body in the closing direction of the valve. Increases in the fuel pressure, therefore, result in movement in a minus direction. Hereby, when the fuel pressure increases, there will be a great delay in valve opening timing.

Next, when the injection pulse falls and the magnetic attraction force is attenuated by the termination of energization, the valve body driving force starts decreasing and the valve begins closing in the timing, T2, that the valve body driving force decreases below zero. If T2 is delayed, therefore, fuel injection will be continued even during that period.

In the example of FIG. 5, the attenuation of the coil current starts from around 12. When the injection pulse width increases, however, although this is not shown in the figure, the attenuation of the coil current will start from 13. In this case, compared with the T2 existing when the injection pulse interval is long, T2 at short injection pulse intervals will naturally increase the injection volume as well. Resultantly, as shown in FIG. 5, linearity will decrease in a low injection volume region.

This indicates that since the current feedback duration (Tc) is too long for the assumed fuel pressure, the supply current value is too great.

FIG. 6 shows an example in which, by the application of the present invention, the valve opening pulse, Tb, is set to a shorter value, Tb′, then the current feedback duration is cut at the valve opening pulse, Tb, and the mode is changed to abrupt current reduction. The coil current, after being abruptly reduced at Tb′, is controlled to the second hold current level, 13. In the end, when the injection pulse falls, the coil current is attenuated from 13. As shown by the solid line in FIG. 6, therefore, the valve body driving force significantly decreases at T2′, the timing point at which the valve body driving force decreases below zero. Consequently, the valve also closes early and the injection volumes in the region shown by hatching in the figure are reduced.

Hereby, the linearity of the fuel injection volume with respect to the injection pulse width, Ta, is greatly improved.

FIG. 7 is a diagram showing the status in which a fuel higher than that of FIG. 6 in terms of pressure was supplied to injector 8 by use of the valve opening pulse width Tb′ yielding the optimum linearity selected in FIG. 6 and the injector was driven. The high fuel pressure applies large force in the closing direction of the valve body, reducing the driving force of the valve body significantly. For this reason, the valve-opening zero crossing point, T1h, is significantly delayed and, in spite of continued injection pulse output, the valve-closing zero crossing point takes a shorter value (Ta−T2h′). This indicates that even if the injection pulse width, Ta, is increased above Ta−T2h′, the valve opening time will not increase and thus the fuel injection volume will not increase, either. In short, the above indicates that at high fuel pressure, with the valve opening pulse width, Tb′, that was adopted in FIG. 6, the injection volume cannot be controlled because of the injection pulse width, Ta, as shown in FIG. 7.

Furthermore, the above indicates that the current feedback duration is too short for the high fuel pressure assumed in FIG. 7.

As shown in FIG. 8, if, under this situation, the valve opening pulse width is returned to the Tb value assumed in FIG. 5, the current feedback duration will be prolonged and the valve body of injector 8 will close the valve after the injection pulse width, Ta, has been reached. Thus, injection control according to the particular injection pulse width will be possible and linearity will also improve.

In the end, the current feedback duration that was set in FIG. 5 is too long for low fuel pressure, but moderate for high fuel pressure. Conversely, the current feedback duration that was set in FIG. 6 is moderate for low fuel pressure, but too short for high fuel pressure.

The present invention provides a function that improves the linearity of the injection volume by adjusting the valve opening pulse width, Tb, according to the particular fuel pressure. More specifically, during fuel pressure detection, when the fuel pressure increases, the current feedback duration will be prolonged by increasing the valve opening pulse width, Tb, and when the fuel pressure decreases, the current feedback duration will be prolonged by reducing Tb.

FIG. 9 is a diagram representing the relationship between the supply fuel pressure to the injector, and the valve opening pulse duration. Data is set in CPU 5 so that as shown in example (A), the valve opening pulse duration is reduced at low fuel pressure and increased at high fuel pressure.

Also, in example (B), unlike example (A) in which stepless control of the valve opening pulse duration is employed, independent suitable valve opening pulse duration values are set for high fuel pressure and low fuel pressure each. Thus, the storage capacity required and the composition of the logic circuit can be minimized. Although two stages are employed in this example of embodiment, more than two stages can also be provided and the number of selectable stages can be determined in a practical range.

FIG. 10 is a diagram indicating that the injector driving control apparatus according to the present invention is valid for heat reduction. This figure shows the situation under which, at low fuel pressure, the injector is driven under the condition of a short current feedback duration (in FIG. 10a, zero). High voltage is applied at up to time T10 and the current is attenuated to 13 to maintain a large current value around 11. At this time, since the energy, AELP, consumed by Zener diode 40 to abruptly reduce the current is large, the amount of heat generated per driving cycle increases. However, since fuel injection at low fuel pressure occurs almost under low-speed driving conditions, the driving frequency of the injector is low and the possibility of problems arising from the generation of heat is reduced.

At high fuel pressure, on the other hand, the current feedback duration is prolonged and the energy, AEHP, consumed by Zener diode 40 to abruptly reduce the current becomes much smaller than AELP and the amount of heat generated per driving cycle decreases. At high rotational speed, although fuel injection usually uses a high fuel pressure, since the amount of heat generated per driving cycle is small, the possibility of problems arising from the generation of heat is reduced.

Irrespective of whether the fuel pressure is high or low, the boost high-voltage application duration is constant at T10, and this makes it unnecessary to add the time during which the boost voltage and the battery voltage are to be applied to the coil, and is very valid for heat reduction.

In this example of embodiment, although its circuit composition is disclosed in FIG. 3, the composition of the present invention is not confined to this figure and the invention is valid for circuits provided with functions similar to those of the circuits shown in the figure.

According to the present invention, it is possible to achieve the linearity of the flow characteristics of the injector used at variable fuel pressures, and at the same time to significantly reduce the amount of heat generated.

### BRIEF DESCRIPTION OF THE DRAWINGS

FIG. 1 is a block diagram showing the circuit composition of the present invention;

FIG. 2 is a flowchart showing the operation of FIG. 1;

FIG. 3 is an internal circuit diagram of the injector driving circuit shown in FIG. 1;

FIG. 4 is a timing chart showing the operation of FIG. 3;

FIG. 5 is a diagram showing the driving status existing at low fuel pressure and with a long current feedback duration;

FIG. 6 is a diagram showing the driving status existing at low fuel pressure and with a short current feedback duration;

FIG. 7 is a diagram showing the driving status existing at high fuel pressure and with a short current feedback duration;

FIG. 8 is a diagram showing the driving status existing at high fuel pressure and with a long current feedback duration;

FIG. 9 is a diagram showing the relationship between fuel pressure and the setting of a current feedback duration; and

FIG. 10 is a diagram showing current-based comparisons between low fuel pressure and high fuel pressure.

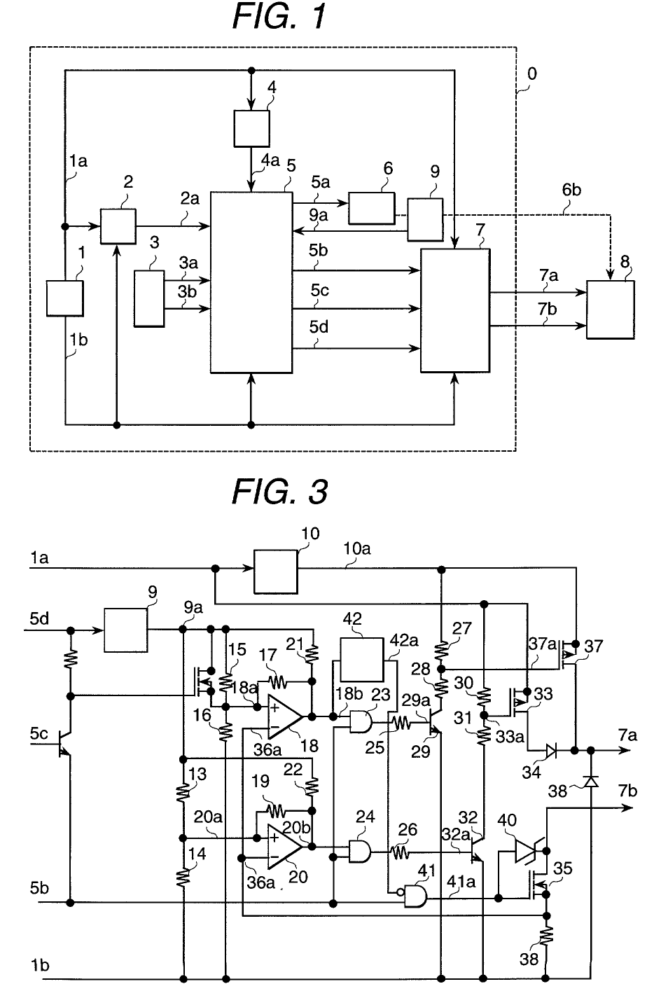

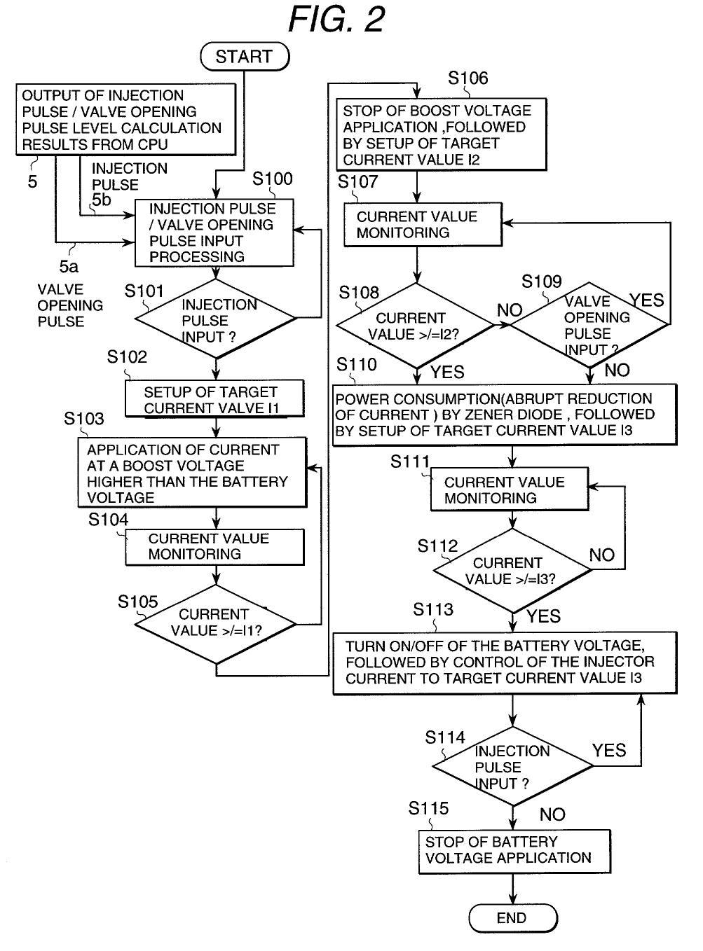

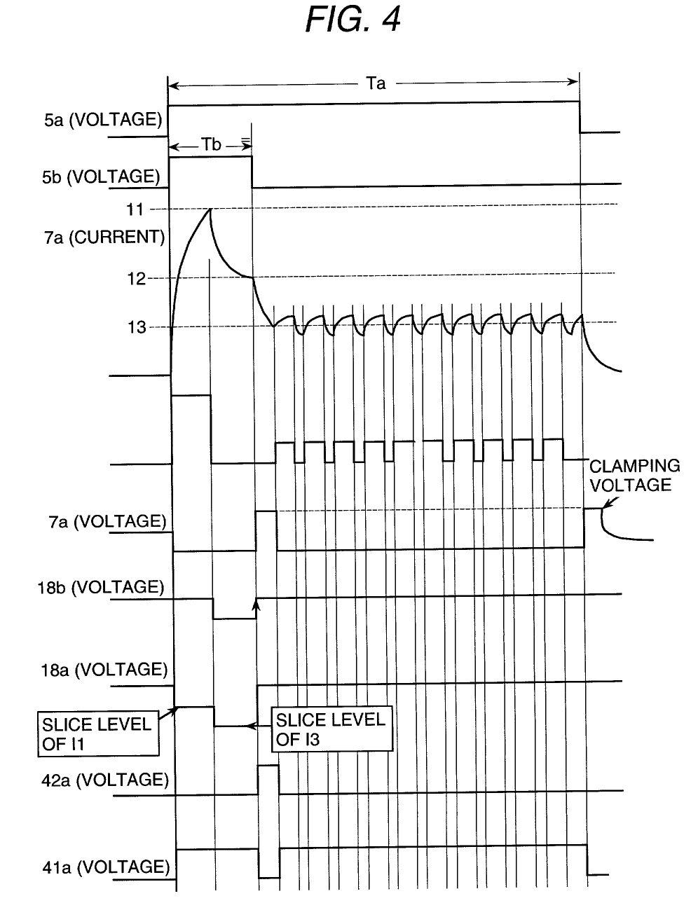

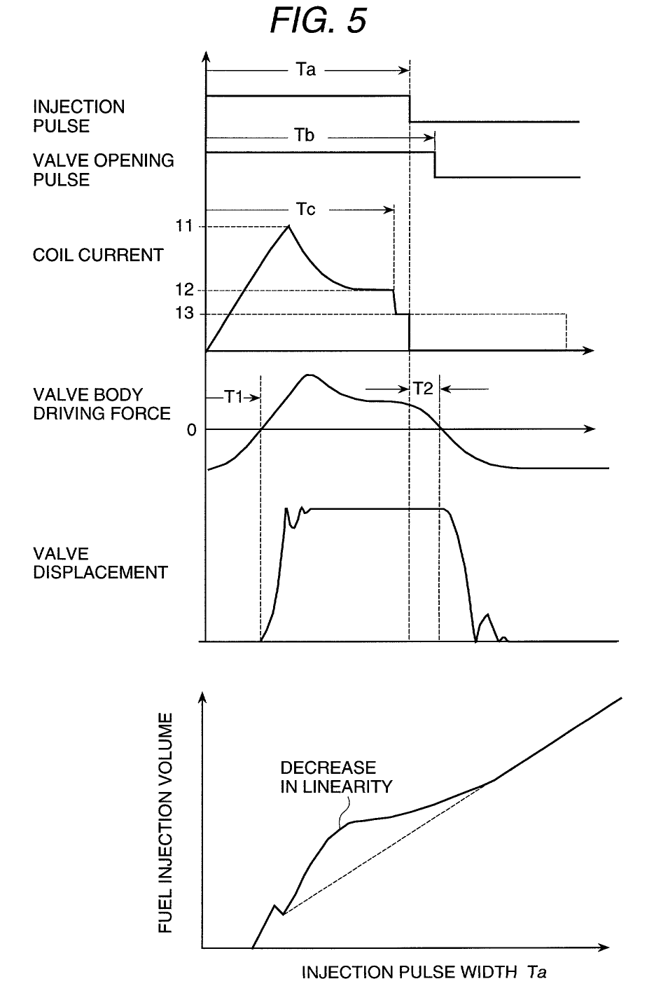

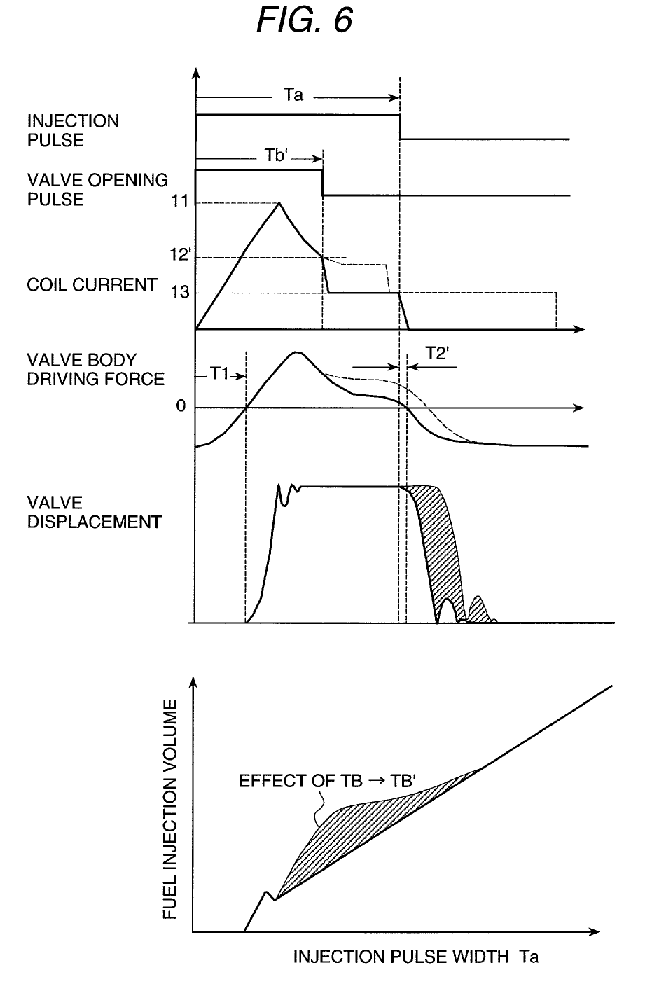

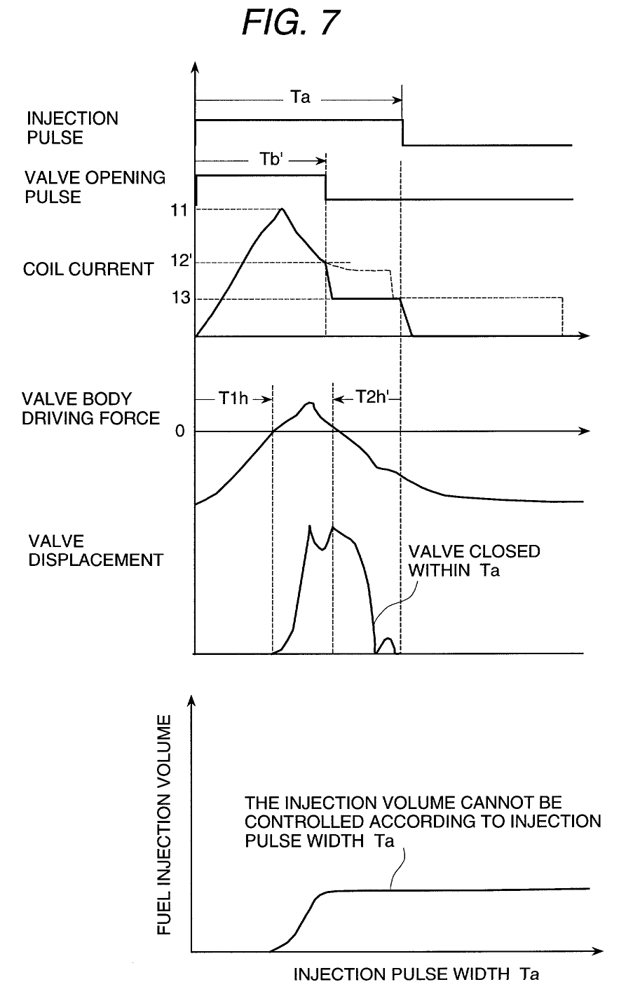

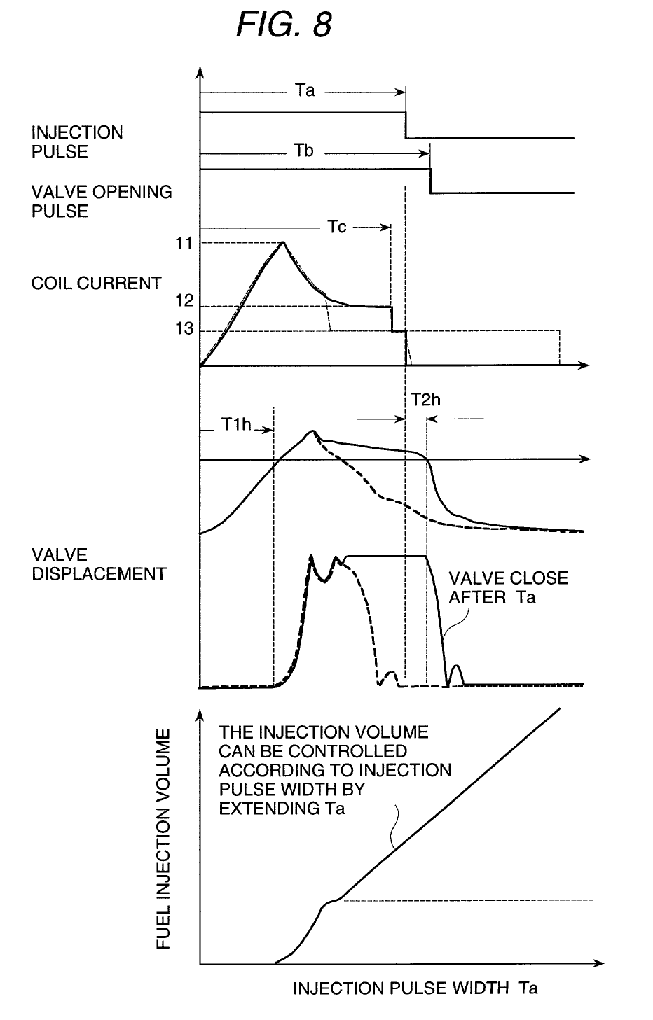

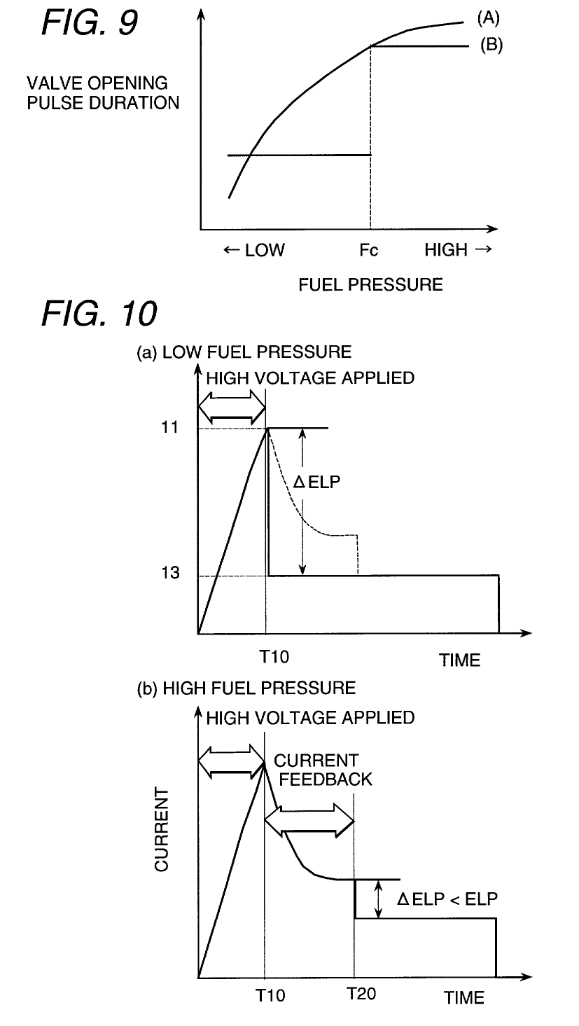

What is claimed is:

1. An injector driving control apparatus comprising
a means for applying a voltage to the coil of an injector until a first target current value has been obtained, and providing control so that once said first current value has been reached, a closed circuit composed of said coil and a current feedback diode is formed and the appropriate current is supplied,
a means for reducing abruptly the current value when it is greater than a second current value smaller than said first current value,
a first operation timing determination means for determining the operation timing of said abrupt current feedback means, and
a second operation timing determination means for determining the operation timing of said abrupt current feedback means preferentially over said first operation timing determination means,
wherein said apparatus is characterized in that the operation timing of said abrupt current feedback means can be changed by use of said second operation timing determination means.

2. An injector driving control apparatus set forth in claim 1 above, wherein said injector driving control apparatus is characterized in that said first operation timing determination means determines the operation timing of said abrupt current feedback means by comparing the coil current value and its setting,
the injector driving control apparatus described above is further characterized in that the operation timing of said abrupt current feedback means can also be changed by use of a timing command current signal received from said control circuit.

3. An injector driving control apparatus comprising
an injector for supplying a fuel to an internal combustion engine,
a switching means for energizing the coil of said injector from a battery,
a control circuit for said switching means,
a means for detecting the current flowing through the coil of the injector,
a current feedback diode for feeding back the coil current of the injector, and
a means for reducing abruptly the coil current of the injector,
wherein said injector driving control apparatus supplies a voltage to the coil of said injector from the start of energization to the attainment of a first target current value, then provides control so as to stop the application of the voltage temporarily on the attainment of said first target current value and so as to supply the appropriate current by forming a closed circuit composed of the coil and said current feedback diode, and thereafter activates said abrupt current feedback means so that the current value, when greater than a second current value smaller than said first current value, is reduced and then the appropriate voltage is applied to obtain said second current value,
and said injector driving control apparatus is further characterized in that the operation timing of the abrupt current feedback means is determined by comparison between the coil current value that has been detected by said detection means, and the value that has been set, and in that said operation timing can also be changed according to the timing command signal sent from said control circuit.

4. An injector driving control apparatus set forth in claim 3 above, wherein said injector driving control apparatus has a means for detecting the pressure of the fuel supplied to said injector and is characterized in that when the fuel pressure increases, the operation timing of said abrupt current feedback means will be changed for delayed operation.

5. An injector driving control apparatus set forth in claim 4 above, wherein said injector driving control apparatus is characterized in that a plurality of operation timing values commensurate with a plurality of fuel pressure ranges, intended for said abrupt current feedback means, are stored within the control circuit for said switching means.

6. An injector driving control apparatus set forth in either claim 3, 4, or 5 above, wherein said injector driving control apparatus is characterized in that during coil current follow-up control for obtaining each of said target current values, the first stage of the control accomplishes energization by applying a boost voltage higher than the voltage of said battery and the second stage of the control accomplishes energization by applying the battery voltage.
